(19) United States
(12) Patent Application Publication
(10) Pub. No.: US 2026/0302035 A1
(43) Pub. Date: Oct. 1, 2026

(54) TRANSFORMER CORE INSULATING COVER

(71) Applicant: ABB Schweiz AG, Baden (CH)

(72) Inventor: Jared M. Davis, Tarboro, NC (US)

(21) Appl. No.: 19/091,364

(22) Filed: Mar. 26, 2025

(51) Int. Cl. H01F 27/02; H01F 19/00

(52) U.S. Cl. CPC H01F 27/022; H01F 19/00

(57) ABSTRACT

An insulating cover for a transformer core is described. The insulating cover includes a seat. The seat defines a channel configured to receive a portion of the transformer core. The insulating cover also includes a lid supported by the seat. The lid is configured to overlay the channel when positioned on the seat. The insulating cover is configured to enclose the portion of the transformer core within the channel.

### TECHNICAL FIELD

The field of the disclosure relates generally to insulating covers, and more particularly, to insulating covers for transformer cores that can be efficiently installed and that improve consistency in the manufacturing of transformer assemblies.

### BACKGROUND

Core boots are used to protect, insulate and seal transformer assembly components. Currently in the industry, core boots are only capable of protecting, sealing and insulating certain parts of transformer cores for transformer assemblies when positioned on these transformer cores. As a result, additional padding needs to be manually cut and installed to cover the other parts of the transformer core that are not covered by these existing core boots. The manual process of cutting and installing the additional required padding can result in variability in the application and quality of this additional padding and reduced efficiency in the transformer assembly and manufacturing of these transformer assemblies. The existing core boots and additional padding also need to be manually wrapped in semi-conductive tape once properly positioned on the transformer core. The wrapping of the semi-conductive tape introduces additional variability and inefficiency in the manufacturing process of transformer assemblies.

Based on the foregoing, a need exists for an insulating cover for a transformer core that can be efficiently installed and improve consistency in the manufacturing of transformer assemblies, and reliably seal, insulate and protect the transformer assembly.

This background section is intended to introduce the reader to various aspects of art that may be related to various aspects of the present disclosure, which are described and/or claimed below. This discussion is believed to be helpful in providing the reader with supporting information to facilitate a better understanding of the various aspects of the present disclosure. Accordingly, it should be understood that these statements are to be read in this light, and not as admissions of prior art.

### BRIEF DESCRIPTION

In one aspect, an insulating cover for a transformer core is described. The insulating cover comprises a seat. The seat defines a channel configured to receive a portion of the transformer core. The insulating cover further comprises a lid supported by the seat. The lid is configured to overlay the channel when positioned on the seat. The insulating cover is configured to enclose the portion of the transformer core within the channel.

In another aspect, a transformer assembly is described. The transformer assembly comprises a transformer core and an insulating cover overlaying a portion of the transformer core. The insulating cover comprises a seat. The seat defines a channel configured to receive a portion of the transformer core. The insulating cover further comprises a lid supported by the seat. The lid is configured to overlay the channel when positioned on the seat. The insulating cover is configured to enclose the portion of the transformer core within the channel.

In yet another aspect, a method of locating a transformer core in an insulating cover is described. The insulating cover comprises a seat defining a channel configured to receive a portion of the transformer core and a lid supported by the seat. The seat comprises movable arms separated by a distance. The lid is configured to overlay the channel when placed on the seat. The method comprises locating the transformer core in the channel defined by the seat and locating the lid on the seat.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 depicts a perspective view of a transformer assembly with a first embodiment of an insulating cover overlaying a transformer core of the transformer assembly;

FIG. 2A depicts a perspective view of a first exterior surface of a seat of the insulating cover of FIG. 1;

FIG. 2B depicts a perspective view of a second exterior surface of the seat of the insulating cover of FIG. 1;

FIG. 3 depicts a perspective view of a lid of the insulating cover of FIG. 1;

FIG. 4 depicts a perspective view of a first portion of an embodiment of an insulating cover;

FIG. 5 depicts a perspective view of a second portion of an embodiment of the insulating cover of FIG. 4;

FIG. 6 depicts a perspective view of an embodiment of an insulating cover for a transformer core;

FIG. 7 depicts a perspective view of a transformer assembly with a second embodiment of an insulating cover overlaying a transformer core of the transformer assembly;

FIG. 8A depicts a perspective view of a first exterior surface of a seat of the insulating cover of FIG. 4;

FIG. 8B depicts a perspective view of a second exterior surface of the seat of the insulating cover of FIG. 4;

FIG. 9 depicts a perspective view of a lid of the insulating cover of FIG. 4;

FIG. 10 depicts a perspective view of the transformer assembly and the seat of the insulating cover of FIG. 1 while a transformer core of the transformer assembly is positioned within a channel of the seat;

FIG. 11 depicts a perspective view of the transformer assembly and the seat of the insulating cover of FIG. 1 once the transformer core of the transformer assembly is positioned within a channel of the seat;

FIG. 12 depicts a perspective view of the transformer assembly, the seat, and the lid of the insulating cover of FIG. 1 while the lid is being attached to the seat;

FIG. 13 depicts a perspective view of a transformer assembly after each of a primary lead, secondary leads, secondary terminals are attached to the transformer assembly of FIG. 1;

FIG. 14 depicts a perspective view of a cast body encompassing the transformer assembly of FIG. 13; and

FIG. 15 depicts a flowchart of an exemplary method of locating a transformer core in an insulating cover.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

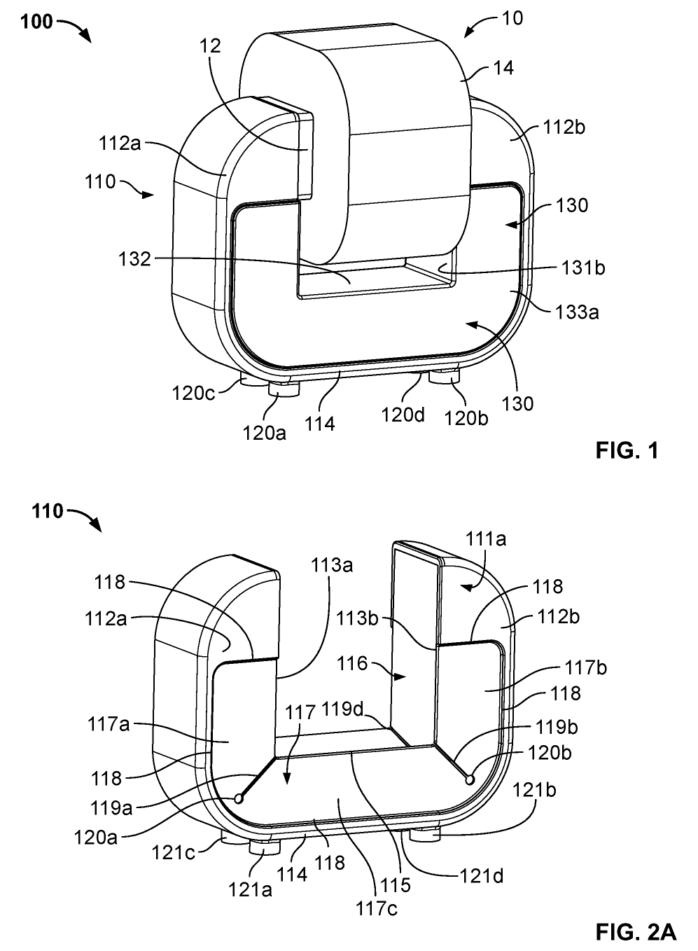

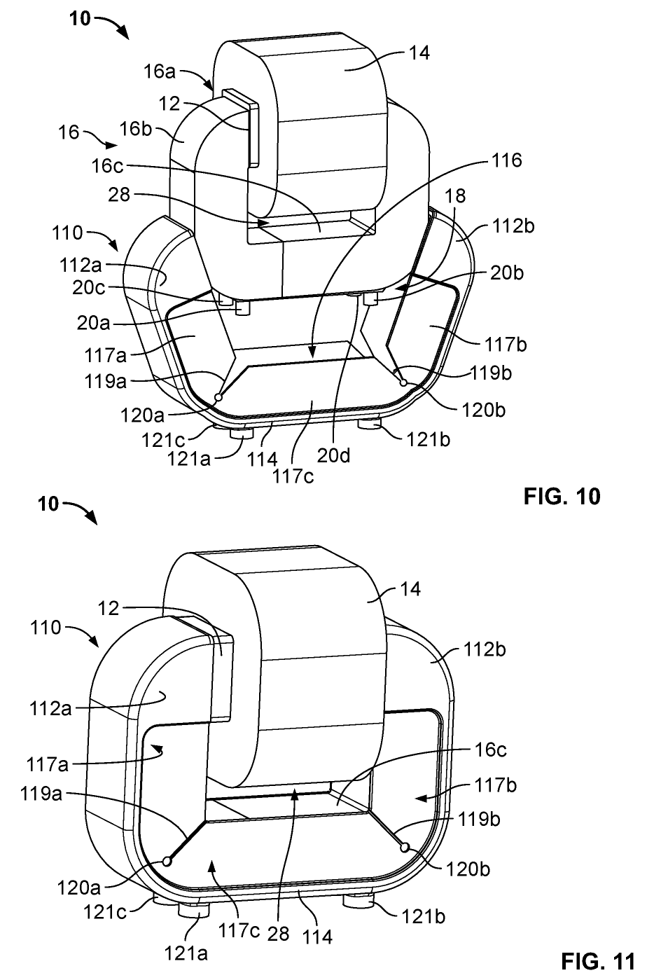

FIG. 1 illustrates a transformer assembly 10 including a first embodiment of an insulating cover 100 overlaying a transformer core 16 of the transformer assembly 10. The transformer core 16 is shown specifically in FIG. 10. The transformer assembly 10 includes a winding tube 12. The winding tube 12 may provide a consistent base for a plurality of windings 14 to be wound around an outer portion of the winding tube 12. The winding tube 12 may provide support to the plurality of windings 14 to prevent deformation and/or shifting of the plurality of windings 14 to maintain a desired arrangement of the plurality of windings 14. By maintaining the desired arrangement for the plurality of windings 14, the winding tube 12 may be used to maintain efficient energy transfer within the transformer assembly 10 once installed. The winding tube 12 may have a cross-sectional shape that defines a first channel extending through the winding tube 12. For example, the cross-sectional shape may be substantially square, circular, or the like. The cross-sectional shape of the winding tube may correspond to the cross-sectional shape of a transformer core 16 (shown in FIG. 10) to receive a first portion 16a of the transformer core 16. The winding tube 12 may be made of an electrically insulating material, such as cardboard, plastic, or the like, to surround and insulate the first portion 16a of the transformer core 16 and prevent electrical short circuits.

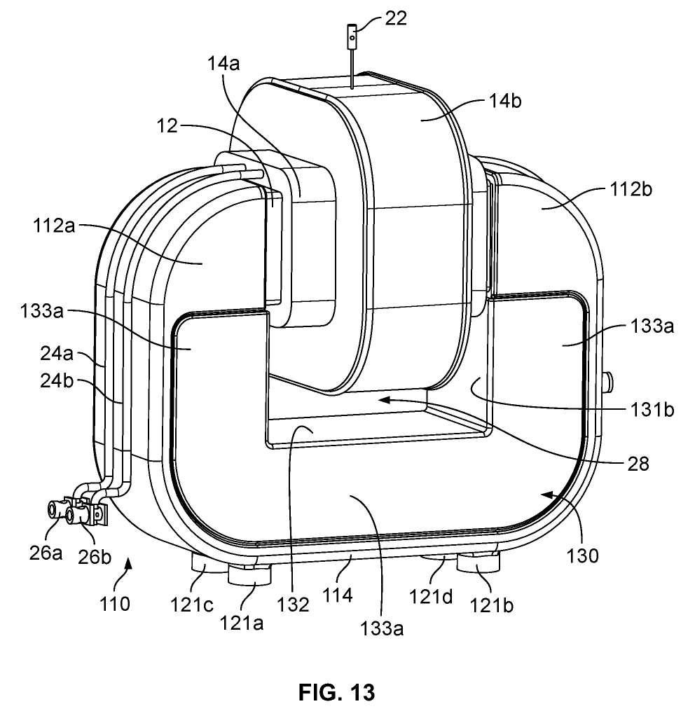

The transformer assembly 10 includes a plurality of windings 14 wound on an exterior surface of the winding tube 12. The plurality of windings 14 may include a first winding 14a wound around an exterior of the winding tube and a second winding 14b wound around the first winding 14a, as shown in FIG. 13. The first winding 14a may include a first plurality of layers of windings wound concentrically around the winding tube 12 with insulation located between each of the first plurality of layers. The second winding 14b may include a second plurality of layers wound concentrically around the first winding 14a with insulation located between each of the second plurality of layers. The second winding 14b is configured to receive an input voltage from an input voltage supply (not shown). Once the second winding 14b receives the input voltage, a current (e.g., alternating current (AC), or the like) starts to flow through the second winding 14b and a changing magnetic field is created around the first winding 14a and the second winding 14b. The magnetic field may induce a current in the first winding 14a to produce a transformed voltage. The first winding 14a then provides the transformed voltage to a load (not shown).

The transformer core 16 provides a pathway for the changing magnetic field to travel within the transformer assembly 10. The transformer core 16 may also be configured to enable efficient energy transfer between the second winding 14b and the first winding 14a. As described above, a first portion 16a of the transformer core 16 may be positioned within and insulated by the winding tube 12. The transformer core 16 includes an uninsulated outer portion 16b (shown in FIG. 10) and an uninsulated inner portion 16c (shown in FIG. 10) that are each left uncovered by the winding tube 12. For example, the uninsulated outer portion 16b may be any exterior surface such as the sides and the outer faces of the transformer core 16 and the uninsulated inner portion 16c may the inner faces of the transformer core 16.

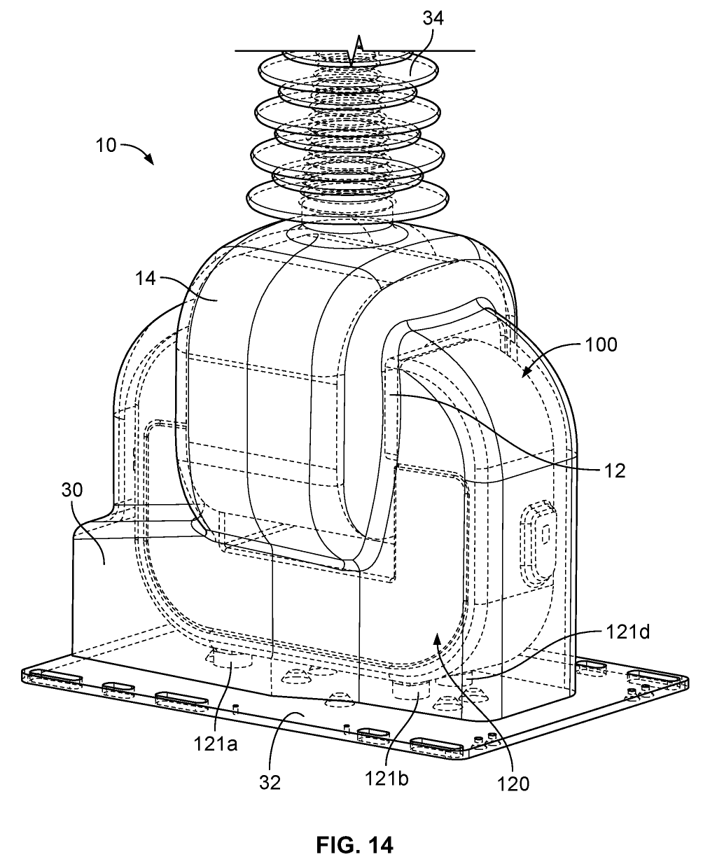

The transformer assembly 10 may include a base 18 attached to the transformer core 16. The base 18 may include a plurality of legs 20a, 20b, 20c, 20d. The plurality of legs 20a, 20b, 20c, 20d may be used to attach the transformer assembly 10 to a mold base (not shown) for a molding and/or casting process for the transformer assembly 10 and/or a base plate, such as base plate 24 shown in FIG. 14.

The transformer assembly 10 includes an insulating cover 100 overlaying the uninsulated outer portion 16b and the uninsulated inner portion 16c of the transformer core 16. The insulating cover 100 includes a seat 110 and a lid 130 supported by the seat 110, as shown in FIG. 1. The discrete lid 130 is shown in FIG. 3. The lid 130 is removably located on the seat 110. The seat 110 may be made of a non-conductive material, such as ethylene propylene diene monomer (EPDM), polyurethane foam, neoprene, or the like. The lid 130 may be made of a non-conductive material, such as EPDM, polyurethane foam, neoprene, or the like, or a semi-conductive material, such as conductive EPDM or the like. The insulating cover 100 may be quickly and efficiently positioned on the transformer core 16 during assembly of the transformer assembly 10 to enclose the uninsulated inner portion 16c and the uninsulated outer portion 16b of the transformer core 16 positioned within the seat 110 and the lid 130, as shown in FIG. 1.

The seat 110 comprises a pair of opposing arms 112a, 112b joined by a middle portion 114 that extends between the opposing arms 112a, 112b. The arms 112a, 112b and middle portion 114 form a U-shaped configuration. The arms 112a, 112b and middle portion 114 define a channel 116 that receives the uninsulated outer portion 16b and the uninsulated inner portion 16c of the transformer core 16.

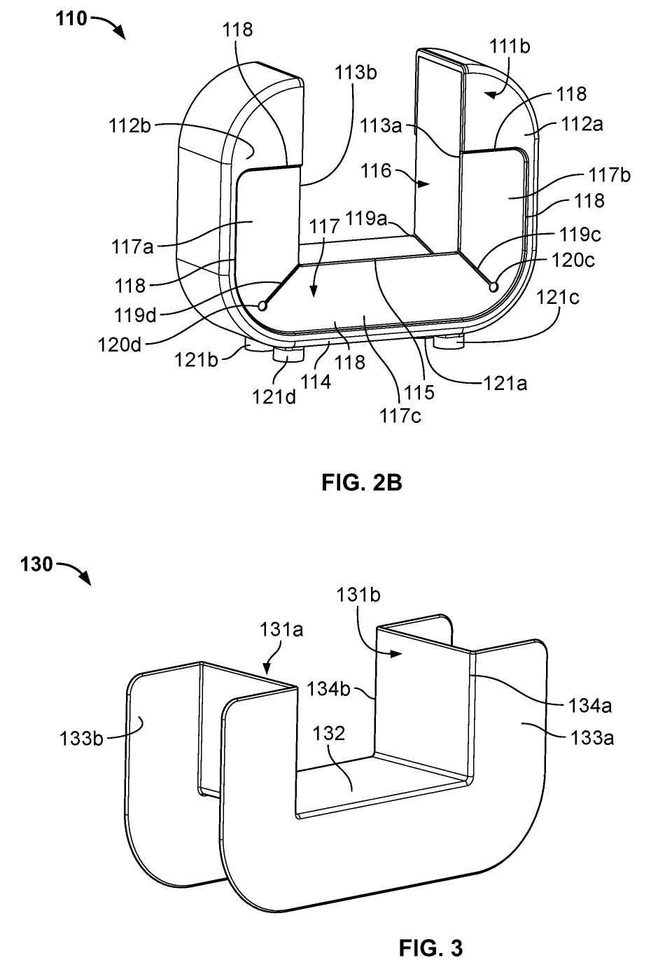

FIG. 2A illustrates an exterior surface 111a of the seat 110 for the insulating cover 100. FIG. 2B illustrates an exterior surface 111b of the seat 110 for the insulating cover 100. A recess 117 is formed on the exterior surfaces 111a,111b of the seat 110, specifically on the arms 112a, 112b and middle portion 114. As will be described in further detail below, the recess 117 is formed and configured to receive the lid 130 when the lid 130 is located on the seat 110. The first arm 112a may have an edge 113a. The second arm 112b may have an edge 113b. The middle portion 114 may have an edge 115. Edge 113a, edge 113b, and edge 115 may collectively define an inner edge of the seat 110.

The channel 116 is sized and configured to receive and house the transformer core 16. For example, the channel 116 may be about 3.032 inches wide, about 11.11 inches in length, and about 8.585 inches in height to correspond to the transformer core 16. The channel 116 allows the seat 110 to overlay the uninsulated outer portion 16b of the transformer core 16 when the transformer core 16 is disposed within the channel 116.

The recess 117 formed on the opposing exterior surfaces 111a, 111b of the seat 110 is defined by an edge 118. The recess 117 includes first, second and third recess areas 117a, 117b and 117c respectively on respective arms 112a, 112b and middle portion 114. The recess areas 117a, 117b, 117c extend from the channel 116 towards the outer periphery of the seat 110. The first, second and third recess areas 117a, 117b, 117c are defined along the outer periphery of the recess areas by the edge 118. The edge 118 may be formed along any portion of each of the arms 112a, 112b and the middle portion 114 such the recess areas 117a, 117b, 117c may only extend along a portion of each of the arms 112a, 112b and the middle portion 114 towards the outer periphery of the seat 110.

The seat 110 may include a first slit 119a and second slit 119b formed within the recess 117 on the exterior surface 111a. The first slit 119a may extend from a corner where an edge 113a of the first arm 112a and edge 115 of the middle portion 114 meet along the exterior surface 111a. The second slit 119b may extend from a corner where an edge 113b of the second arm 112a and edge 115 of the middle portion 114 meet along the exterior surface 111a. The recess 117 on the exterior surface 111b may also include slits that are substantially similar to slits 119a, 119b, such as slit 119c and slit 119d (shown in FIG. 2B). For example, a slit 119c along the second surface may extend from a corner where an edge 113a of the first arm 112a and edge 115 of the middle portion 114 meet along the exterior surface 111b and a slit 119d may extend from a corner where an edge 113b of the second arm 112a and edge 115 of the middle portion 114 meet along the exterior surface 111b. The slits 119a, 119c enable the first arm 112a to be flexed in a direction away from the second arm 112b, as shown in FIG. 10, to facilitate positioning of the seat 110 on the transformer core 16 to thereby cover the transformer core 16 to protect the transformer core 16 during use. The slits 119b, 119d enable the second arm 112b to be flexed in a direction away from the first arm 112a, as shown in FIG. 10, to facilitate positioning of the seat 110 on the transformer core 16.

The slit 119a extends toward the outer periphery of the seat 110 and terminates at a bulb 120a at an end of the slit 119a distal from the corner where the edge 113a of the first arm 112a and the edge 115 of the middle portion 114 meet along the exterior surface 111a. The slit 119b extends toward the outer periphery of the seat 110 and terminates at a bulb 120b at an end of the slit 119b distal from the corner where the edge 113b of the second arm 112a and the edge 115 of the middle portion 114 meet along the exterior surface 111a. The slit 119c extends toward the outer periphery of the seat 110 and terminates at a bulb 120c at an end of the slit 119c distal from the corner where the edge 113a of the first arm 112a and the edge 115 of the middle portion 114 meet along the exterior surface 111b. The slit 119d extends toward the outer periphery of the seat 110 and terminates at a bulb 120d at an end of the slit 119d distal from the corner where the edge 113b of the second arm 112a and the edge 115 of the middle portion 114 meet along the exterior surface 111b. Each of the bulbs 120a, 120b, 120c, 120d enables the arms 112a, 112b to be flexed as described herein and also prevents tearing of the seat 110 while the first arm 112a and/or the second arm 112b are flexed away from each other during positioning of the transformer core 16 within the channel 116.

The seat 110 may include a plurality of legs 121a, 121b, 121c, 121d. The plurality of legs 121a, 121b, 121c, 121d may correspond to the plurality of legs 20a, 20b, 20c, 20d of the transformer assembly 10 to allow each of the plurality of legs 20a, 20b, 20c, 20d to be inserted and/or pressed into a corresponding leg from the plurality of legs 121a, 121b, 121c, 121d during positioning of the transformer core 16 within the channel 116. Once the transformer core 16 is properly positioned within the channel 116, the legs 20a-20d are located in a corresponding leg 121a-121d of the seat 110.

FIG. 3 illustrates the lid 130 of the insulating cover 100 of FIG. 1. The lid 130 may be quickly and efficiently positioned on the transformer core 16 during assembly of the transformer assembly 10 to overlay an uninsulated inner portion 16c of the transformer core 16. The lid 130 includes a first portion 131a disposed on a first side of the lid 130 and a second portion 131b disposed on a second side of the lid 130. For example, the first portion 131a may serve as a cover for a first portion (e.g., a left side) of the uninsulated inner portion 16c (shown in FIG. 10) and the second portion 131b may serve as a cover for a second portion (e.g., a right side) of the uninsulated inner portion 16c. The lid 130 also includes a central portion 132 that extends between and connects the first and second portions 131a, 131b. The central portion 132 may be sized and configured to extend along a length of the uninsulated inner portion 16c of the transformer core 16 to cover a corresponding portion of the uninsulated inner portion 16c of the transformer core 16. The central portion 132 may connect the first and second portions 131a, 131b to form a substantially U-shape.

The lid 130 may include a U-shaped first flap 133a extending from a first edge 134a of the lid 130. The first flap 133a may extend from each of the first and second portions 131a, 131b and the central portion 132 along the first edge 134a. The first flap 133a may be sized and shaped to substantially correspond to the area defined by recess 117 on one of the exterior surface 111a and exterior surface 111b to allow one of recess 117 on exterior surface 111a and recess 117 on exterior surface 111b to receive the first flap 133a and form a substantially planar surface for the insulating cover 100 on a corresponding exterior surface of the seat 110. The lid 130 may include a U-shaped second flap 133b extending from a second edge 133a of the lid 130. The second flap 133b may extend from each of the first and second portions 131a, 131b and the central portion 132 along the second edge 134b. The second flap 133b may be sized and shaped to correspond to the area defined by recess 117 on one of the exterior surface 111a and exterior surface 111b to allow one of recess 117 on exterior surface 111a and recess 117 on exterior surface 111b to receive the second flap 133b and form a substantially planar surface for the insulating cover 100 on a corresponding exterior surface 111a, 111b of the seat 110.

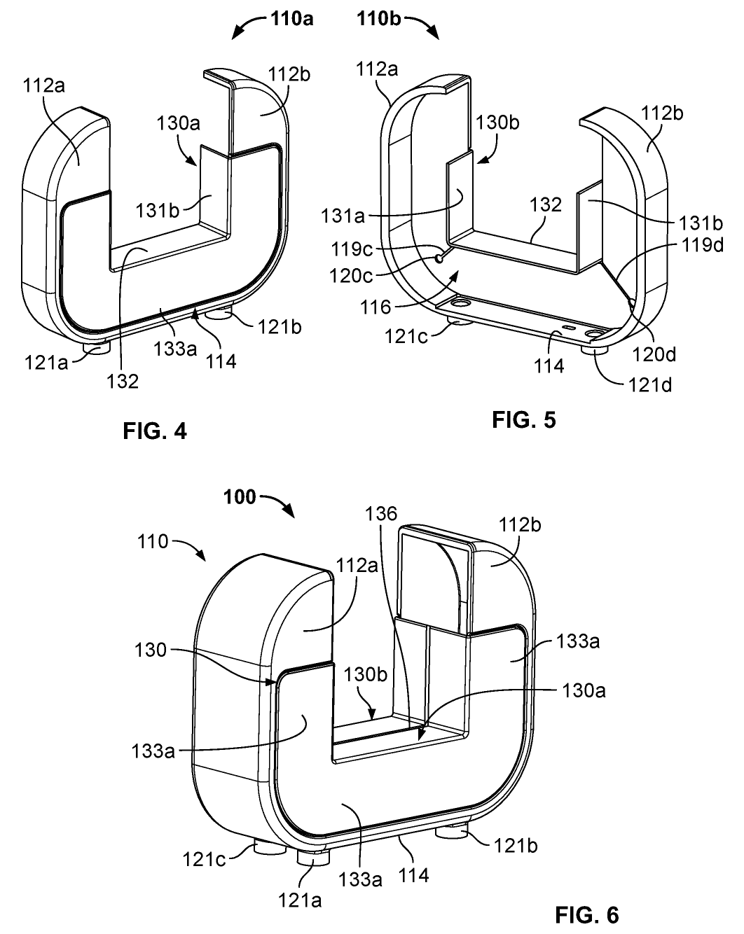

FIGS. 4 and 5 illustrate a first portion 110a and a second portion 110b of an embodiment of an insulating cover 110, respectively. As shown in FIGS. 4 and 5, in some embodiments, a seat for an insulating cover (e.g., seat 110, or the like) may be a 2-piece construction including a first portion 110a and a second portion 110b. The first and second portions 110a, 110b may be formed by splitting the seat 110, as shown in FIGS. 1 and 2, along its longitudinal axis. For example, the first portion 110a may include features from a first side of the seat 110 (e.g., exterior surface 111a or the like) and the second portion 110b may include features from a second side of the seat 110 (e.g., exterior surface 111b or the like).

FIG. 6 depicts a perspective view of an embodiment of an insulating cover 100 for a transformer core. As shown in FIGS. 4-6, in some embodiments, a lid 130 may be a 2-piece construction including a first portion 130a and a second portion 130b. The first and second portions 130a, 130b may be formed by splitting lid 130, as shown in FIGS. 1 and 3, along its longitudinal axis along parting line 136, shown in FIG. 6. For example, the first portion 130a may include features from a first side of the lid 130 such as flap 133a, edge 134a, or the like and the second portion 130b may include features from a second side of the lid 130 such as flap 133b, edge 134b, or the like.

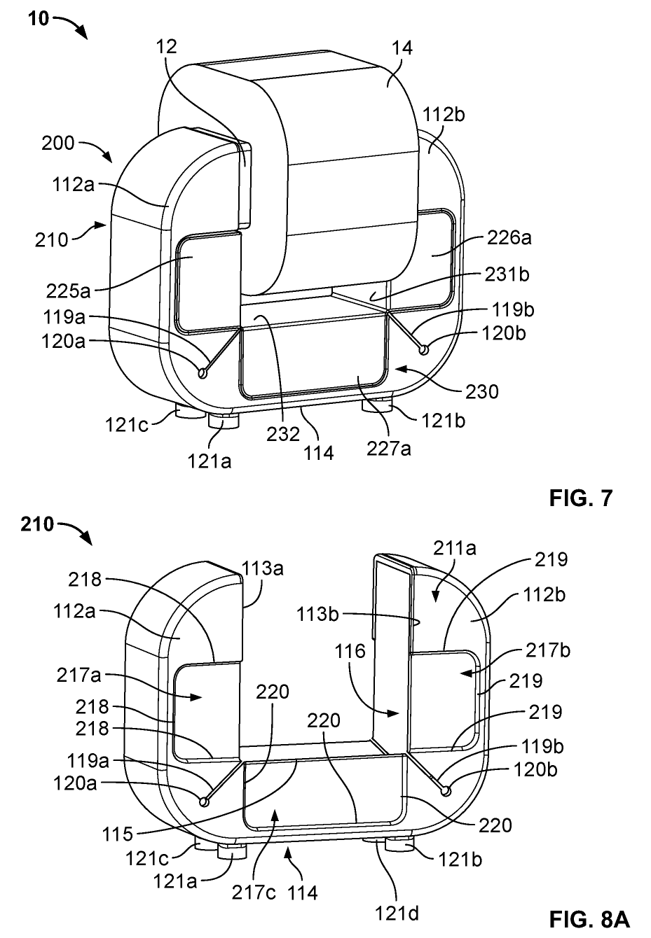

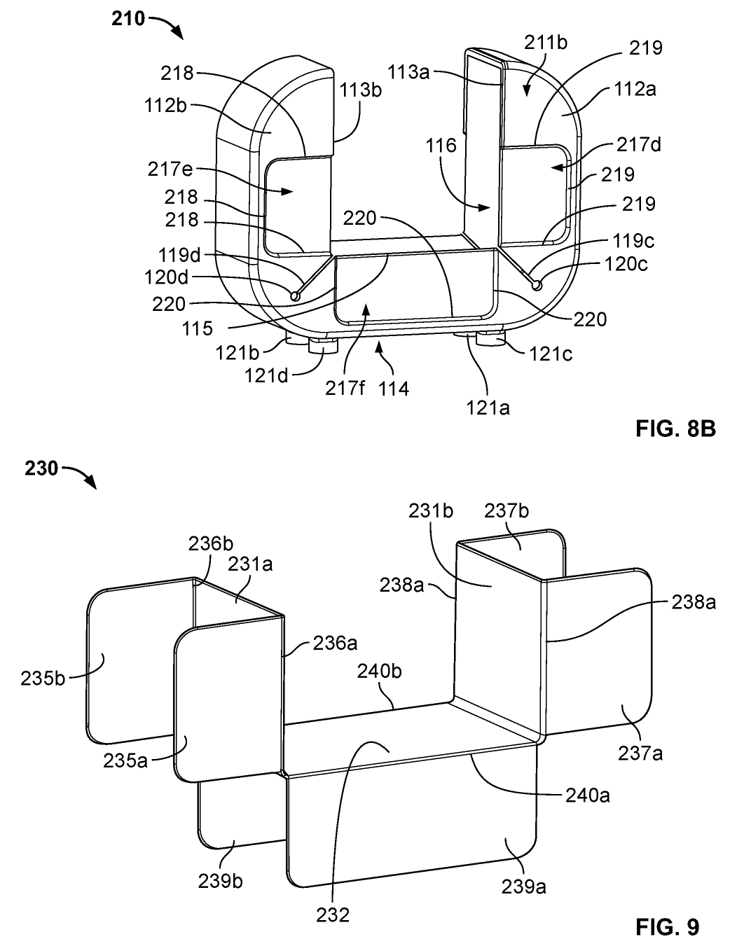

FIG. 7 illustrates a transformer assembly including a second embodiment of an insulating cover 200 overlaying the transformer core 16. The insulating cover 200 includes a seat 210 and a lid 230, as shown in FIG. 7. The insulating cover 200 is configured to enclose the uninsulated inner portion 16c and the uninsulated outer portion 16b of the transformer core 16 within the seat 210 and the lid 230 when each of the lid 230 and the seat 210 are each positioned on the transformer core 16. FIG. 8A illustrates an exterior surface 211a of the seat 210 for the insulating cover 200. FIG. 8B illustrates an exterior surface 211b of the seat 210 for the insulating cover 200. The seat 210 may be made of a non-conductive material, such as EPDM, polyurethane foam, neoprene, or the like. The seat 210 may include features from first embodiment seat 100. For example, as shown in FIGS. 8A and 8B, the seat 210 includes first arm 112a, second arm 112b, middle portion 114, channel 116, slits 119a, 119b, 119c, 119d, and bulbs 120a, 120b, 120c, 120d, and legs 121a, 121b, 121c, 121d, but is not limited thereto. The seat 210 may be quickly and efficiently positioned on the transformer core 16 to overlay an uninsulated outer portion 16b of the transformer core 16.

The seat 210 may include a first recess 217a formed on an exterior surface 211a of the seat 210. The first recess 217a may be defined by an edge 218 that is formed on the first arm 112a. For example, as shown in FIG. 8A, the edge 218 may be U-shaped and formed in the first arm 112a to correspond to a position of the winding tube 12 when the seat 210 is positioned on the transformer core 16 and edge 115 of the middle portion 114.

The seat 210 may include a second recess 217b formed on the exterior surface 211a of the seat 210. The second recess 217b may extend across an exterior portion of the second arm 112b and be defined by an edge 219 that is formed for the second arm 112b. For example, as shown in FIG. 8A, the edge 219 may be U-shaped and formed in the second arm 112b to correspond to a position of the winding tube 12 when the seat 210 is positioned on the transformer core 16 and edge 115 of the middle portion 114.

The seat 210 may include a third recess 217c formed on the exterior surface 211a of the seat 210. The recess 217c may be defined by an edge 220 that is formed on the middle portion 114 For example, as shown in FIG. 8A, the edge 220 may be an elongated U-shape and formed in the middle portion 114 to correspond to edge 113a and edge 113b. The seat 210 may include a fourth recess 217d, a fifth recess 217e, and a sixth recess 217f formed on exterior surface 211b, as shown in FIG. 8B. The fourth recess 217d may be positioned on the first arm 112a and have a structure that is similar to the second recess 217b, the fifth recess 217e may be positioned on the second arm 112b and have a structure that is similar to the first recess 217a, and the sixth recess 217f may be positioned on the middle portion 114 and have a structure that is similar to the third recess 217c.

FIG. 9 illustrates the lid 230 of the insulating cover 200 of FIG. 7. The lid 230 may be quickly and efficiently positioned on the transformer core 16 during assembly of the transformer assembly 10 to overlay an uninsulated inner portion 16c of the transformer core 16. The lid 230 may be made of a non-conductive material, such as EPDM, polyurethane foam, neoprene, or the like, or a semi-conductive material, such as conductive EPDM or the like. The lid 230 includes a first portion 231a disposed on a first side of the lid 230 and a second portion 231b disposed on a second side of the lid 230. For example, the first portion 231a may define a cover for a first portion (e.g., a left side) of the uninsulated inner portion 16c (shown in FIG. 10) and the second portion 231b may define a cover for a second portion (e.g., a right side) of the uninsulated inner portion 16c. The lid 230 also includes a central portion 232 that extends between and connects the first and second portions 231a, 231b. The central portion 232 may be sized and configured to extend along a length of the uninsulated inner portion 16c of the transformer core 16 to cover a corresponding portion of the uninsulated inner portion 16c of the transformer core 16. The central portion 232 may connect the first and second portions 231a, 231b to form a substantially U-shape.

The first cover portion 231a of the lid 230 may include first flap 235a extending from a first edge 236a of the first cover portion 231a and a second flap 235b extending from a second edge 236b of the first cover portion 231a. The first flap 235a and the second flap 235b may be sized and shaped to correspond to seat 210 recess 217a, recess 217b, recess 217d, and/or recess 217e to allow the recesses on either the first arm 112a and the second arm 112b to receive the first flap 235a and the second flap 235b and form a substantially planar surface for the insulating cover 200 on each exterior surface 211a, 211b of the seat 210 on the first arm 112a or the second arm 112b.

The second portion 231b of lid 230 may include third flap 237a extending from a first edge 238a of the second cover portion 231b and a fourth flap 237b extending from a second edge 238b of the second cover portion 231b. The third flap 237a and the fourth flap 237b may be sized and shaped to correspond to seat 210 recess 217a, recess 217b, recess 217d, and/or recess 217e to allow the recesses on either the first arm 112a and the second arm 112b to receive the third flap 237a and the fourth flap 237b and form a substantially planar surface for the insulating cover 200 on each exterior surface 211a, 211b of the seat 210 on the first arm 112a or the second arm 112b.

The third cover portion 232 of lid 230 may include fifth flap 239a extending from a first edge 240a of the third cover portion 232 and a sixth flap 239b extending from a second edge 240b of the third cover portion 232. The fifth flap 239a and the sixth flap 239b may be sized and shaped to correspond to recess 217c and/or recess 217f to allow each of recess 217c and recess 217f to receive one of the fifth flap 239a and the sixth flap 239b and form a substantially planar surface for the insulating cover 200 on each exterior surface 211a, 211b of the seat 210 on the middle portion 114.

FIG. 10 depicts a perspective view of the transformer assembly 10 and the seat 110 of the insulating cover 100 of FIG. 1 while a transformer core 16 of the transformer assembly 10 is inserted into the channel 116 defined by the seat 110. FIG. 11 depicts a perspective view of the transformer assembly and the seat of the insulating cover of FIG. 1 once the transformer core of the transformer assembly is positioned within the channel 116 of the seat 110. As shown in FIG. 10, a transformer assembly 10 comprising a winding tube 12, a plurality of windings 14, and a transformer core 16 having a first portion of the core is disposed within the winding tube is provided. In some embodiments, the plurality of windings 14 comprises a first winding 14a (shown in FIG. 13) wound around an exterior of the winding tube and a second winding 14b (shown in FIG. 13) wound around the first winding. As described above, the winding tube 12 may surround and insulate the first portion 16a of the transformer core 16. An insulating cover (e.g., insulating cover 100, insulating cover 200, or the like) may be used to overlay an uninsulated outer portion 16b (shown in FIG. 10) and an uninsulated inner portion 16c (shown in FIG. 10).

A method of locating a transformer core 16 in an insulating cover 100 includes locating the transformer core 16 of the transformer assembly 10 in a seat 110 of an insulating cover 100. In some embodiments, inserting the transformer core 16 into the seat 110 may comprise moving at least one movable arm 112a, 112b of the seat 110 to increase a distance separating the movable arms 112a, 112b. Moving at least one movable arm 112a, 112b of the seat 110 to increase a distance separating the movable arms 112a, 112b may include longitudinally flexing the first arm 112a in a direction away from the second arm 112 into a flexed position, as shown in FIG. 10, from an initial position, shown in FIG. 11, and/or longitudinally flexing the second arm 112b in a direction away from the first arm 112a into a flexed position, as shown in FIG. 10, from an initial position, shown in FIG. 11. By flexing the arms 112a, 112b away from each other the space between the opposed arms 112a, 112b is increased to thereby facilitate locating the transformer core 16 between the arms 112a, 112b and within the channel 116. Each of slit 119a, bulb 120a, slit 119c, and bulb 120c may prevent tearing of the seat 110 during the longitudinal flexion of the first longitudinal portion 112a. Each of slit 119b, bulb 120b, slit 119d, and bulb 120d may prevent tearing of the seat 110 during the longitudinal flexion of the second longitudinal portion 112b.

Once the transformer core 16 is able to fit between the first arm 112a and the second arm 112b, the transformer core 16 may be inserted into a channel 116. The channel 116 may be defined by an interior surface of the seat 110. During the insertion of the transformer core 16 into the channel 116, each of the plurality of legs 20a, 20b, 20c, 20d of the transformer assembly 10 may be pressed into/inserted into a corresponding leg of the plurality of legs 121a, 121b, 121c, 121d of the seat 110.

Once the transformer core 16 is inserted into the channel 116, the arms 112a, 112b may be moved to return the arms 112a, 112b to their pre-flexed orientation to thereby decrease the distance between the first and second arms 112a, 112b. Each of the first arm 112a and the second arm 112b may be positioned on corresponding portions of the transformer core 16 once the first arm 112a and the second arm 112b are returned to their initial or pre-flexed positions. The first arm 112a may also be pressed into engagement with a first end of a winding tube 12 of the transformer assembly 10, as shown in FIG. 11, when the first arm 112a is longitudinally flexed back into the initial position for the first arm 112a to create a seal on the first end of the winding tube 12. The second arm 112b may also be pressed into engagement with a second end of the winding tube 12, that opposes the first end of the winding tube 12, when the second arm 112b is longitudinally flexed back into the initial position for the second arm 112b to create a seal on the second end of the winding tube 12.

Seat 210 may by positioned on transformer core 16 in a manner similar to the positioning of seat 110 on the transformer core 16, as described above. For example, each of the first arm 112a and the second arm 112b for seat 210 may also be longitudinally flexed to receive the transformer core 16 in the channel 116 defined by seat 210. Alternatively, in an embodiment, two halves (e.g., first portion 110a, 110b, or the like) of a seat 110, 210 may be separated and reassembled to cover the transformer core 16.

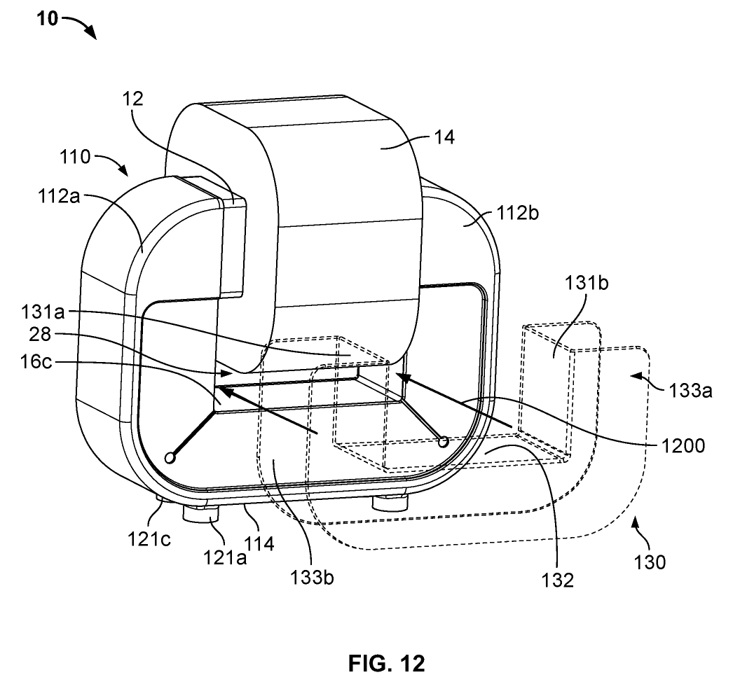

FIG. 12 depicts a perspective view of the transformer assembly 10, the seat 110, and the lid 130 (shown in phantom) of the insulating cover of FIG. 1 while the lid 130 is being attached to the seat 110. A method of locating a transformer core 16 in an insulating cover 100 includes locating the lid 130 on the seat 110. The lid 130 is configured to overlay an uninsulated inner portion 16c of the transformer core 16 when located on the seat 110.

In some embodiments, attaching the lid 130 to the seat 100 may include passing a portion of the lid 130 through a space 28 defined between a winding 14 of the transformer assembly 10 and the transformer core 16, as shown in FIG. 12. For example, the second flap 133b may be passed through the space between the winding 14 and the transformer core 16 in a direction 1200, as shown in FIG. 12. Alternatively, the first flap 133a may be passed through the space 28 defined between the winding 14 and the transformer core 16 in a direction opposite of direction 1200. The lid 130 is pliable and flexible, and as a result, the lid 130 may be contorted to enable the lid 130 to be inserted through the space 28 and, ultimately, be located on the seat 110.

Once the portion of the lid 130 is passed through the space between the winding 14 and the transformer core 16, attaching the lid 130 to the seat 110 may include positioning each of the first flap 133a and the second flap 133b in corresponding recess on a first exterior surface 111a of the seat 110 and a second exterior surface 111b of the seat 110. When each of the first flap 133a and the second flap 133b are positioned within corresponding recesses, the lid 130 and the seat 110 form a substantially planar surface for the insulating cover 100 on each of the exterior surface 111a and the exterior surface 111b of the seat 110 and seal the channel 116. For example, the first flap 133a may be positioned within recess 117 on the exterior surface 111a to form a substantially planar surface on the exterior surface 111a of the seat 110 and the second flap 133b may be positioned within recess 117 on the exterior surface 111b to form a substantially planar surface on the exterior surface 111b of the seat 110.

Lid 230 may by positioned on transformer core 16 in a manner similar to the positioning of lid 130 on the transformer core 16 described above. For example, a portion of the lid 230, such as second flap 235b, fourth flap 237b, and sixth flap 239b, may be passed through the space between the winding 14 and the transformer core 16 in direction 1200. Once the portion of the lid 230 is passed through the space between the winding 14 and the transformer core 16, the first flap 235a may be positioned within recess 217a, and the third flap 237a may be positioned within recess 217b, the fifth flap 239a may be positioned within recess 217c to form a substantially planar surface on the exterior surface 211a of the seat 210 and the second flap 235b may be positioned within recess 217d, and the fourth flap 237b may be positioned within recess 217e, the sixth flap 239b may be positioned within recess 217f to form a substantially planar surface on the exterior surface 211b of the seat 210. Similar to lid 130, lid 230 is pliable and flexible, and as a result, the lid 230 may be contorted to enable the lid 230 to be inserted through the space 28 and, ultimately, be located on the seat 110.

FIG. 13 depicts a perspective view of a transformer assembly after each of a primary lead 22, secondary leads 24a, 24b, and secondary terminals 26a, 26b are attached to the transformer assembly 10 of FIG. 1. The primary lead 22 may be configured to form a connection, such as an electrical connection, between the transformer assembly 10 and an input voltage supply (not shown) to receive an input voltage (e.g., 120 volts or the like). The input voltage is input into the second winding 14b and converted into a desired transformed voltage (e.g., stepped down, or the like) by the transformer assembly 10. The secondary leads 24a, 24b may be configured to form a connection, such as an electrical connection, between the first winding 14a and secondary terminals 26a, 26b. Secondary terminals 26a, 26b may be used to form an output connection, such as an electrical connection, between the transformer assembly 10 and a load to allow the load to receive the transformed voltage from the transformer assembly 10.

The primary lead 22, the secondary leads 24a, 24b, and the secondary terminals 26a, 26b may be similarly positioned on the transformer assembly 10 when the lid 230 and the seat 210 are positioned on the transformer core 16.

FIG. 14 depicts a perspective view of the transformer assembly 10 including a cast body 30 encompassing each of the winding tube 12, the plurality of windings 14, the transformer core 16, the primary lead 22, the secondary leads 24a, 24b, the secondary terminals 26a, 26b and the insulating cover 100. Alternatively, the transformer assembly 10 may include the insulating cover 200. The transformer assembly 10 and the insulating cover 100 may be attached to a mold base (not shown) by the plurality of legs 20a, 20b, 20c, 20d. The plurality of legs 121a, 121b, 121c, 121d of the seat 110 may also form a seal with the mold base. Once the transformer assembly 10 is attached to the mold base, the cast body 30 may be formed over the transformer assembly 10 to encompass each of the winding tube 12, the plurality of windings 14, the transformer core 16, the insulating cover 100, and/or the insulating cover 200. The insulating cover 100, 200 may be used to prevent issues that may arise during forming of the cast body 30. For example, the insulating cover 100, 200 may encompass the transformer core 16, the base 18, and the plurality of legs 20a, 20b, 20c, 20d and provide substantially planar surfaces for each surface of the transformer core 16 to prevent the formation of cracks in the cast body 30 during formation of the cast body 30. Once the cast body 30 is formed, the transformer assembly 10 may be attached to a base plate 32 and a bushing 34 may be disposed around the primary lead 22. The bushing 34 may surround the primary lead 22 to allow the input voltage to be transported safely into the transformer assembly 10.

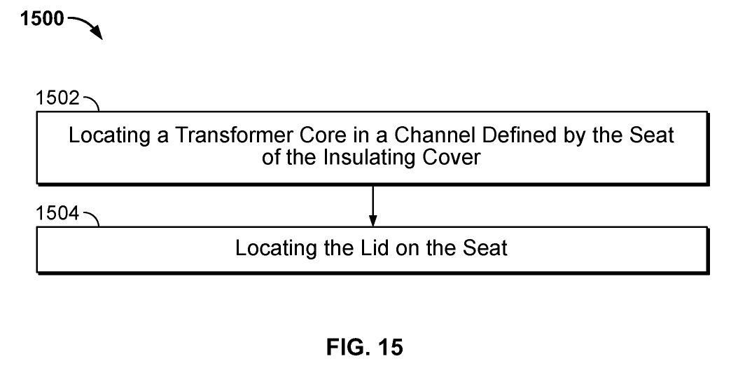

FIG. 15 illustrates a flowchart of an exemplary method 1500 of locating a transformer core 16 in an insulating cover 100, 200. The insulating cover 100, 200 comprises a seat 110, 210 and a lid 130, 230 configured to enclose a portion of the transformer core 16 when each of the lid 130, 230 and the seat 110, 210 are positioned on the transformer core 16. The seat 110, 210 comprises movable arms 112a, 112b separated by a distance and a middle portion 114 connecting the movable arms 112a, 112b. At 802, the method 1500 comprises locating the transformer core 16 in a channel 116 defined by the seat 110, 210. In some embodiments, locating the transformer core 16 in the channel 116 may comprise moving at least one of the movable arms 112a, 112b to increase the distance separating the movable arms 112a, 112b of the seat 110, 210, as described herein, inserting the transformer core 16 into the channel 116 defined by the seat 110, 210, and moving at least one of the movable arms 112a, 112b to decrease the distance separating the movable arms 112a, 112b of the seat 110, 210, as described herein. Moving at least one of the movable arms to decrease the distance separating the movable arms may comprise engaging a first movable arm of the movable arms with a first end of a winding tube of the transformer assembly, and engaging a second movable arm of the movable arms with a second end of the winding tube.

At 804, the method 1500 comprises locating the lid 130, 230 on the seat 110, 210. In some embodiments, locating the lid 130, 230 on the seat 110, 210 may comprise passing the lid 130, 230 through a space 28 between the transformer core 16 and a winding 14 disposed on a portion of the transformer core 16, as described herein, and positioning a plurality of flaps (e.g., flap 133a, flap 133b, flap 235a, flap 235b, flap 237a, flap 237b, flap 239a, flap 239b, or the like) extending from the lid 130, 230 in corresponding recesses (e.g., recess 117, recess 217a, 217b, 217c, 217d, 217e, 217f, or the like) on exterior surfaces 111a, 111b to form a substantially planar surface for the insulating cover 110 on each of the exterior surfaces 111a, 111b and close off the channel 116.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences from the literal language of the claims.

We claim:

1. An insulating cover for a transformer core, the insulating cover comprising:
a seat, the seat defining a channel configured to receive a portion of the transformer core; and
a lid supported by the seat, the lid configured to overlay the channel when positioned on the seat; and
wherein the insulating cover is configured to enclose the portion of the transformer core within channel.

2. The insulating cover of claim 1, wherein the lid comprises:
a first flap on a first side of the lid; and
a second flap on a second side of the lid.

3. The insulating cover of claim 2, wherein the seat comprises:
a first recess on a first exterior surface of the seat, the first recess corresponding to the first flap and configured to receive the first flap to form a substantially planar surface for the insulating cover on the first exterior surface of the seat; and
a second recess on a second exterior surface the seat, the second recess corresponding to the second flap and configured to receive the second flap to form a substantially planar surface for the insulating cover on the second exterior surface of the seat.

4. The insulating cover of claim 1, wherein the lid comprises:
a first body portion comprising a first flap on a first side of the lid and a second flap on a second side of the lid;
a second body portion comprising a third flap on the first side of the lid and a fourth flap on the second side of the lid; and
a third body portion connecting the first body portion and the second body portion, the third body portion comprising a fifth flap on the first side of the lid and a sixth flap on the second side of the lid.

5. The insulating cover of claim 4, wherein the seat comprises:
a first recess disposed on a first arm of the seat along a first exterior surface of the seat, the first recess corresponding to the first flap and configured to receive the first flap; and
a second recess disposed on the first arm along a second exterior surface of the seat, the second recess corresponding to the second flap and configured to receive the second flap.

6. The insulating cover of claim 5, wherein the seat further comprises:
a third recess disposed on a second arm of the seat along the first exterior surface of the seat, the third recess corresponding to the third flap and configured to receive the third flap; and
a fourth recess disposed on the second arm along the second exterior surface of the seat, the fourth recess corresponding to the fourth flap and configured to receive the fourth flap.

7. The insulating cover of claim 6, wherein the seat further comprises:
a fifth recess disposed on a middle portion of the seat, the middle portion extending between and connecting the first arm and the second arm, along the first exterior surface of the seat, the fifth recessed area corresponding to the fifth flap and configured to receive the fifth flap; and
a sixth recess disposed on the middle portion of the seat along the first exterior surface of the seat, the sixth recess corresponding to the sixth flap and configured to receive the sixth flap.

8. The insulating cover of claim 1, wherein the seat comprises a pair of opposing arms and a middle portion that extends between the pair of opposing arms.

9. The insulating cover of claim 8, wherein the seat further comprises a plurality of slits configured to enable movement of each of the pair of opposing arms.

10. A transformer assembly comprising:
a transformer core; and
an insulating cover overlaying a portion of the transformer core, the insulating cover comprising:
a seat, the seat defining a channel configured to receive the portion of the transformer core, and
a lid supported by the seat, the lid configured to overlay the channel when positioned on the seat; and
wherein the insulating cover is configured to enclose the portion of the transformer core within the channel.

11. The transformer assembly of claim 10, wherein the lid comprises:
a first flap on a first side of the lid; and
a second flap on a second side of the lid.

12. The transformer assembly of claim 11, wherein the seat comprises:
a first recess on a first exterior surface of the seat, the first recess corresponding to the first flap and configured to receive the first flap to form a substantially planar surface for the insulating cover on the first exterior surface of the seat; and
a second recess on a second exterior surface of the seat, the second recess corresponding to the second flap and configured to receive the second flap to form a substantially planar surface for the insulating cover on the second exterior surface of the seat.

13. The transformer assembly of claim 10, wherein the lid comprises:
a first body portion comprising a first flap on a first side of the lid and a second flap on a second side of the lid;
a second body portion comprising a third flap on the first side of the lid and a fourth flap on the second side of the lid; and
a third body portion connecting the first body portion and the second body portion, the third body portion comprising a fifth flap on the first side of the lid and a sixth flap on the second side of the lid.

14. The transformer assembly of claim 13, wherein the seat comprises:
a first recess disposed on a first arm of the seat along a first exterior surface of the seat, the first recess corresponding to the first flap and configured to receive the first flap; and
a second recess disposed on the first arm along a second exterior surface of the seat, the second recess corresponding to the second flap and configured to receive the second flap.

15. The transformer assembly of claim 14, wherein the seat further comprises:
a third recess disposed on a second arm of the seat along the first exterior surface of the seat, the third recess corresponding to the third flap and configured to receive the third flap; and
a fourth recess disposed on the second arm along the second exterior surface of the seat, the fourth recess corresponding to the fourth flap and configured to receive the fourth flap.

16. The transformer assembly of claim 15, wherein the seat further comprises:
a fifth recess disposed on a middle portion of the seat, the middle portion extending between and connecting the first arm and the second arm, along the first exterior surface of the seat, the fifth recessed area corresponding to the fifth flap and configured to receive the fifth flap; and
a sixth recess disposed on the middle portion of the seat along the first exterior surface of the seat, the sixth recess corresponding to the sixth flap and configured to receive the sixth flap.

17. A method of locating a transformer core in an insulating cover, the insulating cover comprising a seat defining a channel configured to receive a portion of the transformer core and a lid supported by the seat, the seat comprising movable arms separated by a distance, the lid is configured to overlay the channel when placed on the seat, the method comprising:
locating the transformer core in the channel defined by the seat; and
locating the lid on the seat.

18. The method of claim 17, wherein locating the transformer core in the channel comprises:
moving at least one of the movable arms to increase the distance separating the movable arms;
inserting the transformer core into the channel defined by the seat; and
moving at least one of the movable arms to decrease the distance separating the movable arms.

19. The method of claim 18, wherein moving at least one of the movable arms to decrease the distance separating the movable arms comprises:
engaging a first movable arm of the movable arms with a first end of a winding tube of the transformer assembly; and
engaging a second movable arm of the movable arms with a second end of the winding tube.

20. The method of claim 19, wherein locating the lid on the seat comprises:
passing the lid through a space between the transformer core and a winding disposed on a portion of the transformer core; and
positioning a plurality of flaps extending from the lid in corresponding recesses on exterior surfaces of the seat to form a substantially planar surface for the insulating cover on each of the exterior surfaces and close off the channel.
